(19) United States
(12) Patent Application Publication
(10) Pub. No.: US 2006/0274799 A1
(43) Pub. Date: Dec. 7, 2006

(54) VCSEL semiconductor with ESD and EOS protection

(76) Inventors: Doug Collins, Albuquerque, NM (US); Scott Frederick, Albuquerque, NM (US); Daniel McGlynn, Albuquerque, NM (US); Barry Whitmore, Albuquerque, NM (US)

Correspondence Address: Casey Toohey;Emcore Corp., 1600 Eubank Blvd., SE, Albuquerque, NM, 87123, US

(21) Appl. No.: 11/145,295

(22) Filed: Jun. 3, 2005

(51) Int. Cl. H01S 3/04; H01S 3/00

(52) U.S. Cl. 372/38.09; 372/36

(57) ABSTRACT

A design device and method of manufacturing a vertical cavity surface emitting laser with a visual indicator for determining exposure to electrostatic discharge (ESD) or electrical overstress (EOS). Either an on-chip or off-chip fuse used in series or in parallel with the VCSEL that provides a visual indicator that the device has been subjected to an ESD or EOS event.

### FIELD OF THE INVENTION

The field of the invention relates to vertical cavity surface emitting lasers (VCSELs) and more particularly to improving the reliability of VCSELs by providing devices and circuitry protecting them from electrostatic discharge (ESD) pulses or electrical overstress (EOS).

### BACKGROUND OF THE INVENTION

Vertical cavity surface-emitting lasers (VCSELs) have become the laser technology of choice for transceivers using in Storage-Area Network (SAN) and Local Area Network (LAN) applications. There are two major technology platforms for manufacturing VCSELs. The difference in these platforms is based on the different techniques of current confinement, either by ion-implantation or confined by oxide layers. In the ion implantation technique, ions are implanted in a portion of the upper reflection layer so as to form a high resistance region, thereby confining the current flow to a defined region. In the selective oxidation technique, the peripheral region of a mesa structure is oxidized, thereby defining an aperture surrounded by a high resistance region.

A typical VCSEL configuration includes an active region between two mirrors, disposed one after another on the surface of the substrate wafer. An insulating region forces the current to flow through a small aperture, and the device lases perpendicular to the wafer surface (i.e., the “vertical part of VCSEL”). One type of VCSEL in particular, the proton VCSEDL, wherein the insulating region is formed by a proton implantation, dominated the early commercial history of VCSELs. In the oxide-guided VCSEL, the insulating region is formed by partial oxidation of a thin, high aluminum-content layer within the structure of the mirror.

The use of electro-static discharge (ESD) protection devices for integrated circuits is known in the prior art. For example, U.S. Pat. No. 6,794,715 to Lui et al. provides a circuit structure for ESD protection and methods for making the circuit structure. Specifically, a p-n junction is formed between a first diffusion region and a second diffusion region that breaks down in response to an ESD pulse, thereby causing discharge current to harmlessly flow across a portion of the substrate.

Like any semiconductor device, susceptibility to ESD damage is an important manufacturing and reliability issue. A semiconductor device or integrated circuit (IC) may be exposed to ESD from many sources, such as static electricity generated by automated assembly equipment or the human body. A major source of ESD exposure for such devices is from the human body. For instance, a charge of about 0.6 μC can be induced on a hyman body with a body capacitance of 150 pF. When the charged human body comes into contact with the pins of an IC, an electrical path through the IC may result and the applied current may cause damage to the individual devices in the IC. Such a discharge event is typically simulated by reliability engineers using a Human Body Model (HBM), which, in one example, includes a 100-150 pF capacitor discharged through a switching component and a 1.5 kOhm resistor into an IC.

A discharge similar to the HBM event can also occur during the manufacturing or assembly process when the IC comes into contact with a charged conductive object, such as a metallic tool or fixture. This is typically modeled by a so-called machine model (MM). In one example, the MM includes a 200 pF capacitor discharged directly into the IC. The MM is sometimes referred to as the worst-case HBM.

The transfer of charge from the IC is also an ESD event. The IC may become charged, for example, from sliding down a feeder in an automated assembler. If it then contacts a metal insertion head or other conductive surface, a rapid discharge may occur from the device to the metal object. This event is typically modeled by a Charged Device Model (CDM). Because the IC itself becomes charged in a CDM event, and discharges to ground, the discharge current flows in the opposite direction in the IC as compared to that of an HBM event or MM event. Although the duration of the CDM discharge is typically very short, often less than one nanosecond, the peak current can reach several tens of amperes. Thus, the CDM discharge can be more destructive than the HBM event for some ICs.

Many commonly used ICs contain elements, such as transistors, resistors, capacitors and interconnects, that can fail when an ESD event occurs thereby affecting the quality, reliability, yield, delivery and cost of ICs. As a result, IC product failure from ESD is an important concern in the semiconductor microelectronics industry; and industry standards require that IC products withstand a minimum level of ESD. To meet this requirement, ESD protection circuitry is generally build into the input, output, and/or power supply circuits of an IC.

The ability to produce workable ESD protection structures depends upon the interrelationship of IC's topology, the design layout, the circuit design, and the fabrication process. Various circuit designs and layouts have been proposed and implemented for protecting ICs from ESD.

VCSEL devices are susceptible to electrostatic discharge events because of smaller active volume. ESD events occur where a static charge builds up and is subsequently discharged. When the static charge discharges through a VCSEL, it may be catastrophically damaged. U.S. Pat. No. 6,185,240 to Jiang et al. describes ESD protection for VCSEL devices in which a VCSEL and diode are fabricated on a common substrate and where the diode is in parallel reverse orientation to the VCSEL. When a reverse biased ESD event is applied to the VCSEL, the parallel connected diode provides a very low resistance path to quickly drain off the charge before it can damage the VCSEL. Since the reverse biased ESD damage threshold is typically lower than the forward biased ESD damage threshold, the Jiang solution increases the VCSEL ESD threshold tolerance damage level.

Still other means of protecting ICs from ESD, EOS or CDM is through the use of fusible links or fuse networks connected between a power supply and ground, such as described in U.S. Pat. No. 6,762,918 to Voldman. In this case the fuse networks are used for enabling/disabling circuits/circuit blocks.

In order to make the fusible link/network useful, the prior art has assumed that some type of circuitry must be used to determine the state of the fuse (e.g., open/closed). In addition, circuit elements are often intentionally blown (via electrical means) or optical means (via laser energy) for purposes of programming a circuit. In these cases, the techniques used for blowing the circuit elements can induce enough energy to lead to EOS or ESD failure of the circuitry used to read the state of the fuse (i.e., the fuse state circuitry). For example, the electrical current to open a circuit element or fuse can lead to currents which cause failure of the fuse element and the fuse state circuitry at the same time. In further example, the use of a laser to blow a circuit element can lead to conversion of optical to thermal energy where the thermal energy can lead to an electrical current, forming a pulsed electrical spike propagating into the fuse state circuitry.

Prior to the present invention, there has not been an effective technique directed to protecting VCSELs from EOS. Accordingly, a need exists for better methods of protecting VCSELs.

### SUMMARY

Briefly, and in general terms, the present invention provides a VCSEL semiconductor devices formed on a substrate with a fusible conductor disposed on the substrate in series with the VCSEL and designed to form an open circuit when the device is subjected to an electrostatic discharge pulse.

### BRIEF DESCRIPTION OF THE DRAWINGS

FIG. 1 is a schematic of a VCSEL circuit in accordance with an illustrated embodiment of the invention;

FIG. 2 is a top view of the VCSEL of FIG. 1;

FIG. 3 is an isometric view of the circuit of FIG. 2; and

FIG. 4 is a schematic of a VCSEL circuit in accordance with an alternate embodiment of the invention.

### DETAILED DESCRIPTION OF AN ILLUSTRATED EMBODIMENT

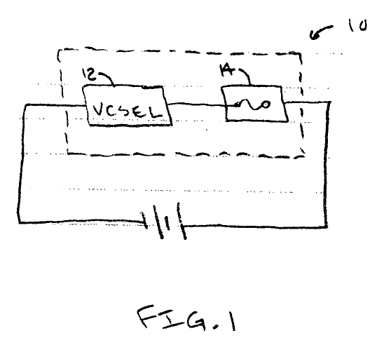

FIG. 1 is a schematic of a VCSEL circuit 10 shown generally in accordance with an illustrated embodiment of the invention. In a first illustrated embodiment, a circuit 10 includes a VCSEL 12 with ESD protection such as an external electronic device 14 connected in series with the VCSEL 12 and functioning to protect said VCSEL 12 against ESD surges. As depicted in FIG. 1 the external device 14 is an indicating fusible link that provides a visual indication of whether said VCSEL has been subjected to an ESD surge. In particular, the application of an ESD surge may cause the fusible link to be “blown” indicating that the assembly has been subjected to an ESD event. As a result, visual inspection of the assembly may be used as a quality control measure, either at the point of manufacture, or by a user of the VCSEL.

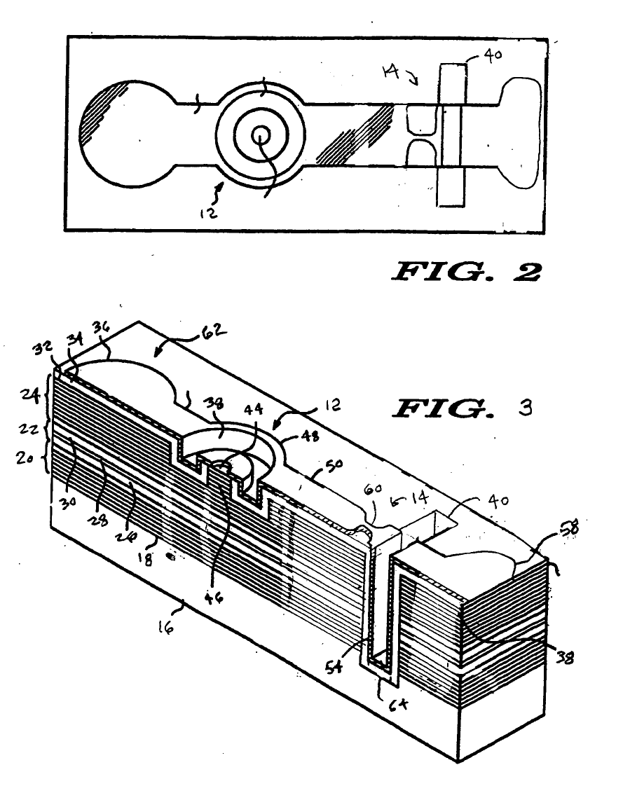

FIG. 2 is a top view of the VCSEL circuit 10 of FIG. 1 FIG. 3 is an enlarged isometric diagram of a semiconductor substrate 16 with a surface 18 having a VSCSEL 12 and a fusible link 14 fabricated as part of a single process, wherein the VCSEL 12 and fusible link 14 are shown in section. The VCSEL 12 and fusible link 14 may be fabricated as part of a common substrate structure that includes a number of functionally active layers including the substrate 16, a first stack 20 of distributed Bragg reflectors (DBRs), an active region 22, a second stack 24 of DBRs, a surface 32, a dielectric layer 34 and conductive layer 62. Conductive layer 62 may include conductive portions (traces) 36, 48, 50, 54, 58. The active region 20 may include a first cladding region 26, an active region 28 and a second cladding region 30.

It should be understood that FIG. 3 is a sectional view of VCSEL 12 and fusible link 14, with portions removed to show in section and to illustrate the inner construction of the circuit 10. Also, FIG. 2 is a top plan view that illustrates the overall relationship between the various components. The circuit 10 may represent one of a plurality of circuits 10 that make up an array. Additionally, FIG. 3 has been simplified by purposely omitting some engineering details so as to more clearly illustrate the present invention.

VCSEL 12 may be fabricated on any suitable substrate, such as gallium arsenide, silicon, indium gallium phosphide, or the like having a surface 32. Generally, the surface 32 is processed to form several epitaxial layers including the stack 20, the active area 22 (including first cladding region 26, active region 28 and second cladding region 30) and the stack 24. The active area 22 and stacks 20, 24 may be created using any suitable epitaxial process (e.g., MBE, MOVPE, etc.).

Once the active area 22 and stacks 20, 24 have been created, current confinement areas may be created for the VCSEL 12 and fusible link 14. In the context of the VCSEL 12, the current confinement area may be either of the mesa or the trench type variety. For purposes of explanation, the VCSEL 12 will be assumed to use a trench 38 as the current confinement area.

The trench 38 defines the VCSEL 12. The trench 38 extends from the surface through the stack 24 to a point just above the active area 22. As such, when current flows into the VCSEL 12 through the trench 38, the current stimulates the active layer 22 to generate light that is reflected between stacks 20, 24. The laser light generated by this process is emitted through an orifice 44.

Trench 40 provides an optional connection between the fusible link 14 and the substrate 16, as discussed in more detail below. The trench 40 may extend from the surface 32 into the substrate 16.

It should be understood that the trenches 38, 40 may be created by any suitable method or combination of methods (e.g., photolithography, etching, etc.). It should also be understood that the creation of the trenches 38, 40 may be accomplished by a combination of steps.

Once the trenches 38, 40 have been created, a dielectric layer 34 may be disposed over selected portions of the exposed surfaces. The dielectric layer 34 may be of any of a number of suitable materials (e.g., nitride, oxynitride, oxide, etc.).

The dielectric layer 34 may be patterned using a masking material to remove the dielectric layer 34 from specific areas (e.g., the orifice 44). Once the dielectric 34 has been patterned, an appropriate etching process may be used to remove the dielectric (e.g., fluorine based plasma chemistry, a wet etch HF solution, etc.).

Once the dielectric material 34 has been deposited, a conductive layer may be disposed over the upper surface. The conductive layer may be of any appropriate material (e.g., aluminum, gold, silver, etc.).

Once the conductive layer has been disposed over the top surface, a masking material may be used to mask certain areas. Once the top surface has been masked, the exposed areas may be etched to remove the conductive material.

The upper surface may be masked to provide an orifice conductive layer 48 inside the trench 38 and around the orifice 44. A trace 50 along the top surface and trench traces 54 may be used to connect a supply pad 58 to the VCSEL 12 through the fusible link element 60. The size (cross-sectional area) of the fusible link element 60 may be controlled by the masking material to be of sufficient size to vaporize upon application of the appropriate transient to the supply pad 58.

In this embodiment, the supply pad 58 supplies an activating potential to the VCSEL 12 through the element 60 of the fusible link 14. The location of the element 60 of the fusible link 14 on top of the circuit 10 allows for easy visual inspection and detection of an overvoltage via vaporization of the highly visible element 60.

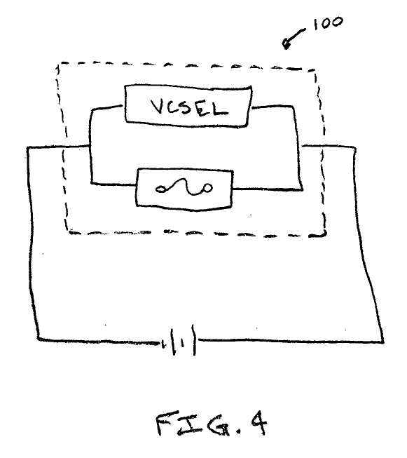

FIG. 4 depicts a highly simplified block diagram 100 of a second embodiment of the present invention in which the external electronic device is in parallel with the VCSEL. Such a configuration may be useful in applications where it is desirable that the laser still be able to operate notwithstanding the ESD event has tripped the fuse. Of course, the visual indicator could still be used to reject the part if employed as part of a quality control procedure.

With regard to the embodiment of FIG. 4, the isometric diagram of FIG. 2 may be used to illustrate this embodiment. In this embodiment, the VCSEL activation potential may be applied to the pad 36 of the conductive layer 62.

One side of the fusible link element 60 may be connected to the supply potential through circuit traces 50. A second side of the link element 60 may be connected to the substrate 16.

Connection of the second side of the link element 60 to the substrate 16 may be accomplished by etching away a portion 64 of the dielectric layer 34 at the bottom of the trench 40. Etching away the dielectric layer exposes the substrate 16. The deposition of the metal layer directly onto the substrate 16 allows the second side of the element 60 to be firmly connected to the substrate 16 without significant modification of the circuit 10.

It should be noted in this regard, that since the fusible link 15 is connected in parallel with the VCSEL 12, the cross-sectional area of the element 60 may be substantially reduced over the cross-sectional area of the first embodiment. In this case, the cross-sectional area may be of only a few microns to provide sufficient resistance to allow for the normal operation of the VCSEL 12 by impedance matching the fusible link with the VCSEL.

A specific embodiment of method and apparatus for protecting a VCSEL has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A vertical cavity surface emitting laser assembly comprising:
a vertical cavity surface emitting laser; and
a fusible link connected to the vertical cavity surface emitting laser to protect the vertical cavity surface emitting laser from electrostatic discharge pulses or electrical overstress.

2. The vertical cavity surface emitting laser assembly as in claim 1 wherein the fusible link is connected in series with the vertical cavity surface emitting laser.

3. The vertical cavity surface emitting laser assembly as in claim 1 wherein the fusible link is connected in parallel with the vertical cavity surface emitting laser.

4. The vertical cavity surface emitting laser assembly as in claim 1 further comprising a common substrate upon which the vertical cavity surface emitting laser and fusible link are fabricated.

5. The vertical cavity surface emitting laser assembly as in claim 4 further comprising a first bonding pad disposed on a first side of the substrate and a second bonding pad disposed on a second side of the substrate with the fusible link connected between the first and second bonding pads.

6. The vertical cavity surface emitting laser assembly as in claim 5 further comprising a trench disposed between the fusible link and the second connection pad.

7. The vertical cavity surface emitting laser assembly as in claim 6 wherein the trench further comprises a depth that extends through the functionally active layers to the substrate.

8. The vertical cavity surface emitting laser assembly as in claim 1 wherein the fusible link provides a visible indicator that the vertical cavity surface emitting laser has been subject to an electrostatic discharge pulse or electrical overstress.

9. The vertical cavity surface emitting laser assembly as in claim 1 wherein the laser assembly further comprises a housing within which the vertical cavity surface emitting laser and fusible link are disposed, said housing having a window that enables visual examination and determination of whether the fusible link has been broken and therefore that the vertical cavity surface emitting laser has been subjected to an electrostatic discharge pulse or overstress.

10. The vertical cavity surface emitting laser assembly as in claim 9 further comprising a set of pins attached to the housing to allow the housing to be connected to a printed circuit board.

11. The vertical cavity surface emitting laser assembly as in claim 1 wherein the fusible link further comprises a diameter and length where an impedance of the fusible link matches an impedance of the vertical cavity surface emitting laser.

12. A vertical cavity surface emitting laser comprising:
a substrate;
the vertical cavity surface emitting laser fabricated on the substrate; and
a fusible link fabricated on the substrate and connected to the vertical cavity surface emitting laser that that detects whether the vertical cavity surface emitting laser has been subjected to an electrostatic discharge pulse.

13. The vertical cavity surface emitting laser assembly as in claim 12 wherein the fusible link is connected in series with the vertical cavity surface emitting laser.

14. The vertical cavity surface emitting laser assembly as in claim 12 wherein the fusible link is connected in parallel with the vertical cavity surface emitting laser.

15. The vertical cavity surface emitting laser assembly as in claim 12 wherein the vertical cavity surface emitting laser further comprises a plurality of functionally active layers disposed on the substrate.

16. The vertical cavity surface emitting laser assembly as in claim 15 further comprising a dielectric layer that separates the fusible link from the functionally active layers.

17. The vertical cavity surface emitting laser assembly as in claim 12 further comprising a first bonding pad disposed on a first side of the substrate and a second bonding pad disposed on a second side of the substrate with the fusible link connected between the first and second bonding pads.

18. The vertical cavity surface emitting laser assembly as in claim 17 further comprising a trench disposed between the fusible link and the second connection pad.

19. The vertical cavity surface emitting laser assembly as in claim 18 wherein the trench further comprises a depth that extends through the functionally active layers to the substrate.

20. The vertical cavity surface emitting laser assembly as in claim 12 wherein the fusible link further comprises a diameter and length where an impedance of the fusible link matches an impedance of the vertical cavity surface emitting laser.

20. A vertical cavity surface emitting laser comprising:
a substrate;
the vertical cavity surface emitting laser having a plurality of functionally active layers fabricated on the substrate; and
an indicating fusible link that detects whether the vertical cavity surface emitting laser has been subjected to an electrostatic discharge pulse, said fusible link being fabricated on a surface of the substrate with a first end of the fusible link connected to a orifice conductor of the vertical cavity surface emitting laser.

21. A method of protecting a vertical cavity surface emitting laser comprising the steps of:
providing a substrate;
fabricating the vertical cavity surface emitting laser on the substrate;
fabricating a fusible link on the substrate; and
fabricating a connection on the substrate that connects the fusible link in series or in parallel with the vertical cavity surface emitting laser.
